(19) United States
(12) Patent Application Publication
(10) Pub. No.: US 2003/0200054 A1
(43) Pub. Date: Oct. 23, 2003

(54) Method of evaluating the performance of a relief pitcher in the late innings of a baseball game

(76) Inventor: Paul Storch, Great Neck, NY (US)

Correspondence Address: LACKENBACH SIEGEL, One Chase Road, Scarsdale, NY, 10583, US

(21) Appl. No.: 10/128,678

(22) Filed: Apr. 23, 2002

(51) Int. Cl. G06F 15/00

(52) U.S. Cl. 702/182

(57) ABSTRACT

A method of evaluating the performance of a relief pitcher in the late innings of a baseball game factors through data as to when a pitcher inherits at least one player on base. The following steps of the method are disclosed: first, establishing the number of runs R scored by such inherited players; second, establishing the number of batters B faced in such innings; and, finally, evaluating the save-run average “SRA” according to the formula:

$$SRA = k ( \frac{R}{B} ) ,$$

where k is a predetermined constant selected to scale the SRA to a desired magnitude.

### BACKGROUND OF THE INVENTION

1. Field of the Invention

The invention generally relates to baseball and, more particularly, to a statistical method for evaluating the performance of a relief pitcher.

2. Description of the Prior Art

Baseball thrives, and in large measure survives, by its ability to evaluate, differentiate and classify its product—namely, its players and teams. This is true for hitters, for pitchers, and, to a lesser extent, for position players in the field.

Who had the best season at the plate? Generally speaking, the batting average tells us.

Who had the most productive season? Perhaps it's the slugging percentage or the Runs Batted In (RBI) that tells us. Or is it the statistic that indicates which player crossed home plate the most times (Runs Scored)? Or perhaps the statistic that states who had the best on-base average, or the most walks, or the most hits.

Measuring pitching performance has also been one of the most common subjects of statistics, and can be found in newspapers from the 1800s. Which pitcher won how many games? The won/loss columns tell us. This is the most widely used measure of a pitcher's worth. Which pitcher struck out the most batters? Which pitcher yielded the fewest walks? Which pitcher allowed the fewest hits? Which pitcher allowed the fewest batters to cross home plate due to his mistakes (the Earned Run Average, or “ERA”)? This is the second most widely used measure of a pitcher's worth, after the total amount of “wins.” Which pitcher had the most “saves,” so to speak, out of the bullpen? A “save” is credited to a relief (or “substitute”) pitcher when the pitcher who starts the game is removed from the game while his team is in the lead; the relief pitcher holds the opposite team in check so that his team remains ahead and goes on to win the game. (It has been said that the “blown save” is baseball's most “deflating moment, and its most haunting,” The New York Times, Mar. 31, 2002, Sect. 8a, p. 3.)

The following is a more specific definition of a “save” in pitching: A pitcher can earn a save by completing all three of the following terms:

(1) Finishes the game won by his team;

(2) Does not receive the win;

(3) Meets one of the following three items:

(a) Enters the game with a lead of no more than three runs and pitches at least one inning;

(b) Enters the game with the tying run either on base, at bat or on deck; and/or

(c) Pitches effectively for at least three innings.

The number of “saves” has been used for years as a measure of the value of a relief pitcher. Baseball is not immune to society's rush into specialization. Just as a general practitioner M.D. recommends a patient to a specialist, and an attorney might specialize in maritime law, baseball is becoming more and more specialized as to how it uses its players. Very few “complete”—nine-(or more)-inning games—are pitched by the starting pitchers. A manager will use a “pitch count” to determine how far his ace (the starting pitcher) can go. There are middle-inning (fifth-seventh inning) relief pitchers, and there are “closers,” who finish pitching the game.

Relief pitching has become an art and a specialty. However, the statistics related to relief pitching has not kept pace.

Assume the following situation. Several relief pitchers have come into a different number of games and have “inherited” a different number of base runners. However, all of these relief pitchers end the season with similar numbers of saves. Because the actual games each pitcher entered can be widely disparate, a fixed number of saves—say, 15 —might not have the same value for each pitcher. It's possible that reliever no. 1 pitched in twice as many games as reliever no. 2. Clearly, in such a case, “15 saves” would not mean that they are of equal value. And what of the situations in which each of these pitchers allowed runs or scores and did not “save” the game (“blown saves”)?

Most of the baseball statistics we know are readily computed and reflect simple performance parameters. The common and not-so-common items used to measure pitching performance in the major leagues today include “Adjusted Pitching Runs” (“APR” or “PR/A”). This is an advanced pitching statistic used to measure the number of runs that a pitcher prevents from being scored compared to the League's average pitcher in a neutral park in the same amount of innings. This is similar to the “ERA” (“Earned Run Average”) and acts as a quantitative counterpart.

The abovementioned ERA is simply computed by the following formula:

$$ERA = \frac{R \times 9}{I}$$

where R=the number of earned runs and I=total no. of innings pitched.

The ERA is one of the oldest pitching statistics and is one of the most commonly used and understood statistics in the major leagues. Virtually every fan knows what it means, but many often forget the formula used to compute the pitcher's ERA.

The Earned Run Average Plus (“ERA+” or “RA”) is computed by dividing the league ERA by the ERA of a pitcher. This statistic uses a league-normalized ERA in the calculation and is intended to measure how well the pitcher prevented runs from being scoring relative to pitchers in the rest of the league. It is similar to the Hitters' PRO statistic.

Another commonly used statistic is the “Walks and Hits per Innings Pitched” (“WHIP”), which is computed as follows:

$$WHIP = \frac{H + W}{I}$$

where H=number of hits, W=number of walks, and I=total number of innings pitched. There is a popular statistic that is probably used and frequently discussed in certain leagues. It was developed to measure the approximate number of walks and hits a pitcher allows in each inning he pitches, and then to compare the value received to other pitchers to formulate a pitcher's index.

The winning percentage is another common statistic in baseball and is also quite easy to understand and easy to compute. The primary purpose of this statistic is to gauge the percentage of a pitcher's games that are won.

In some instances, certain statistics become very sophisticated and more difficult to compute. Thus, for example, “Game Score” is computed as follows:

$$GAMESCORE = 50 + 3 I - 2 ( H + R + E ) - W + S + \frac{2}{{I}^{′}}$$

where I=the number of innings pitched;

H=number of hits;

R=number of runs;

E=number of errors;

W=number of walks;

S=number of strikeouts; and

I′=the number of each full inning completed beyond the fourth inning.

This advanced pitching statistic is used to measure how dominant a pitcher's performance is in each game he pitches. This statistic rewards dominance (strikes and lack of hits) while penalizing for walks.

As it clear from the above, the number of statistics that are followed by baseball enthusiasts is rather large. Some of these statistics are, of course, more important than others to either the fans or the ball clubs.

While some of the aforementioned pitching statistics reflect a pitcher's general performance, only some of the statistics reflect the additional pressures and expectations of pitchers during critical phases of the game, when the pitchers are under particular stress. As noted, the “Game Score” is a function of full innings completed beyond the fourth inning and, therefore, reflects the performance of the pitcher toward the second half of the game. Most of the pitching statistics do not, however, reflect other parameters that are particularly stressful to pitchers and that good pitchers must overcome, including the number of outs, the number of inherited runners and the specific bases where each inherited runner is located when the relief pitcher comes on. As suggested, the number of outs, the number of inherited runners and the specific bases on which they are located, as well as the specific inning in which the pitcher comes in can, separately and in combination, be particularly stressful to a pitcher. The ability of a pitcher to overcome such stressful conditions and provide a win has never been quantified.

### SUMMARY OF THE INVENTION

Accordingly, it is an object of the invention to provide a method of evaluating the performance of a relief pitcher in the final innings of a baseball game that provides an accurate measure of a pitcher's performance and value of the pitcher under stressful and/or critical conditions.

It is another object of the invention to provide a method, as in the previous object, that factors in parameters such as the number of the inning in which the relief pitcher is called in, the number of inherited runners, and the bases which they occupy, and the number of outs during the inning in which the relief pitcher is called in.

It is still another object of the invention to provide a method as in the previous objects which computes a “Save Run Average” (“SRA”) that is directly proportional to the total number of runs scored by inherited players and inversely proportional to the total number of batters faced by the pitcher in the innings in which he pitches.

It is yet another object of the invention to provide a method of the type under discussion which is simple to compute and yet provides a sophisticated and more refined method of evaluating and comparing the performances of relief pitchers by considering the number of runs scored by inherited players and the number of batters faced during the final innings, but which can be refined by also factoring in the specific innings in which the runs by the inherited runners are scored, as well as the number of outs when the relief pitcher is introduced into the game.

In order to achieve the above objects, as well as others that will become more apparent hereinafter, a method of evaluating the performance of a relief pitcher in the final innings of a baseball game in which the pitcher inherits at least one player on base comprises the steps of establishing the number of runs R scored by such inherited players and establishing the number of batters B faced by the pitcher in such innings. The Save-Run Average (SRA), in accordance with the present invention, is evaluated by calculating it as follows:

$$SRA = k ( \frac{R}{B} )$$

where k=a predetermined constant selected to scale the SRA to a desired range of magnitudes; R=the number of runs scored by inherited players; and B=the number of batters faced by the pitcher in these innings.

### BRIEF DESCRIPTION OF THE DRAWINGS

With the above and additional objects and advantages in view, as will hereinafter appear, this invention comprises the devices, combinations and arrangements of parts hereinafter described by way of example and illustrated in the accompanying drawings of preferred embodiments in which:

FIGS. 1A, 1B and 1C are three sections of the same spreadsheet that illustrates one computation of an SRA on the basis of certain game condition when the relief pitcher is called in; and

FIGS. 2A, 2B and 2C are similar to FIGS. 1A, 1B and 1C, but illustrating a second spreadsheet showing different game conditions and the resulting computation of a different SRA for the pitcher.

### DESCRIPTION OF THE PREFERRED EMBODIMENTS

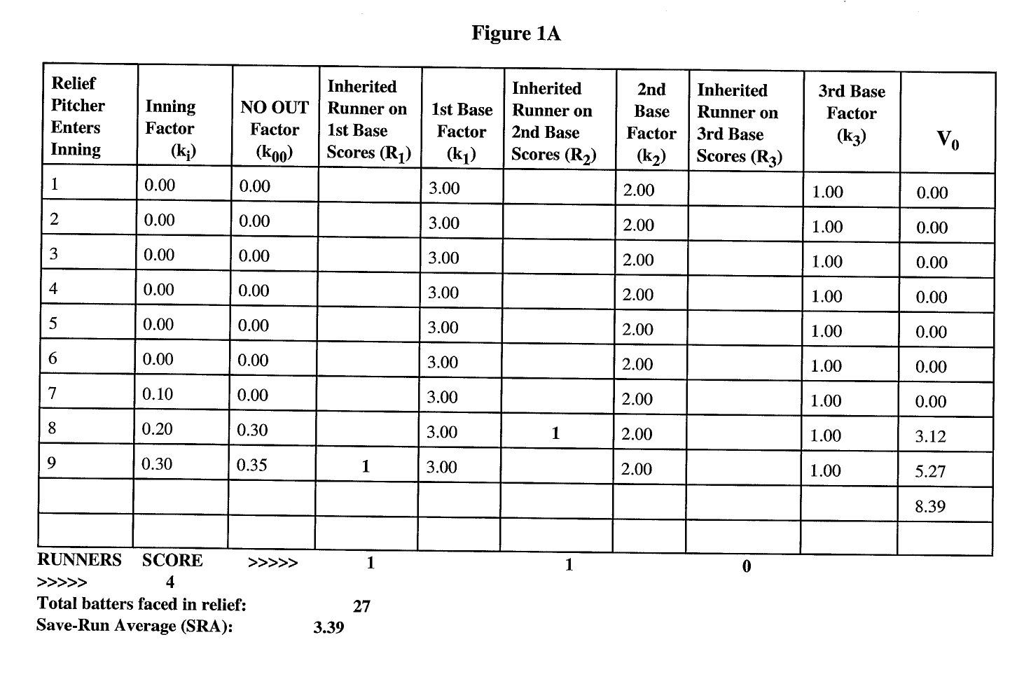

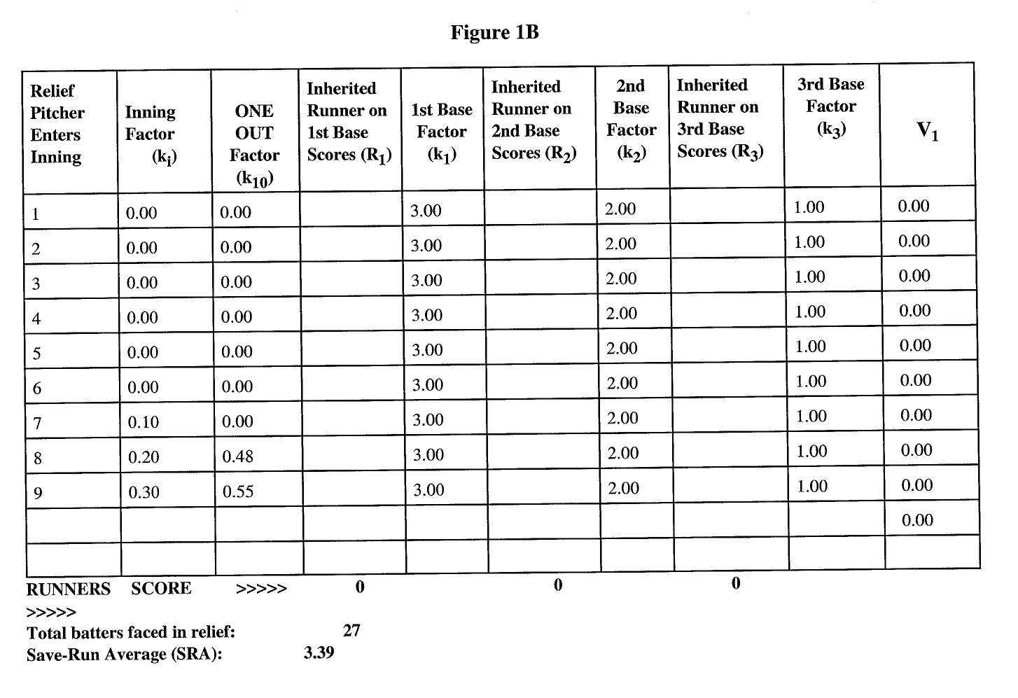

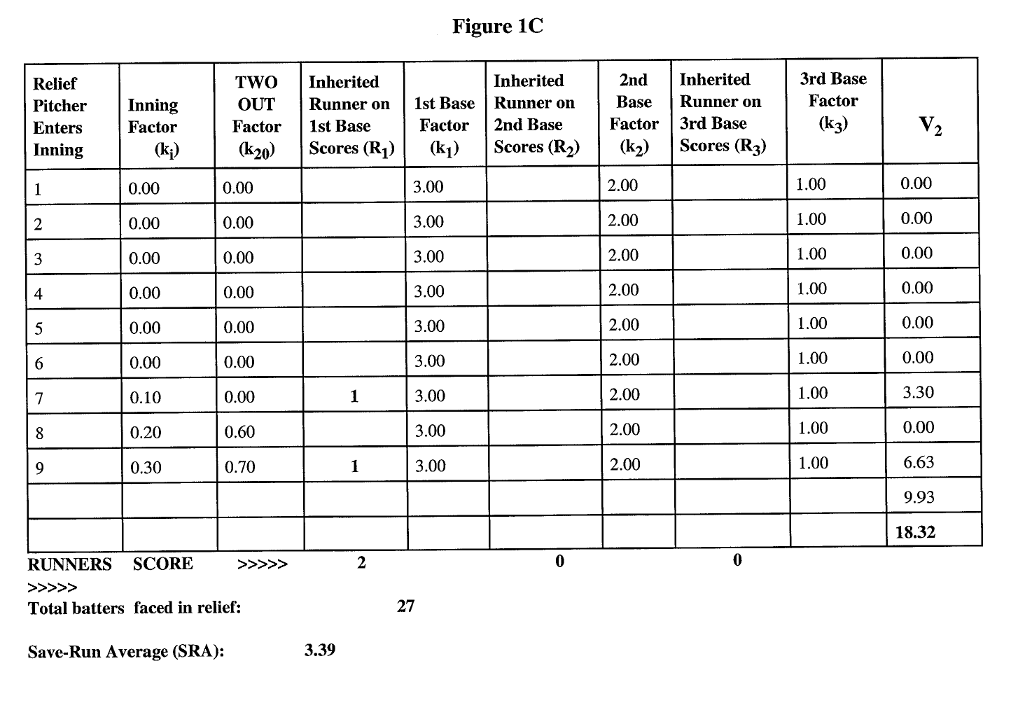

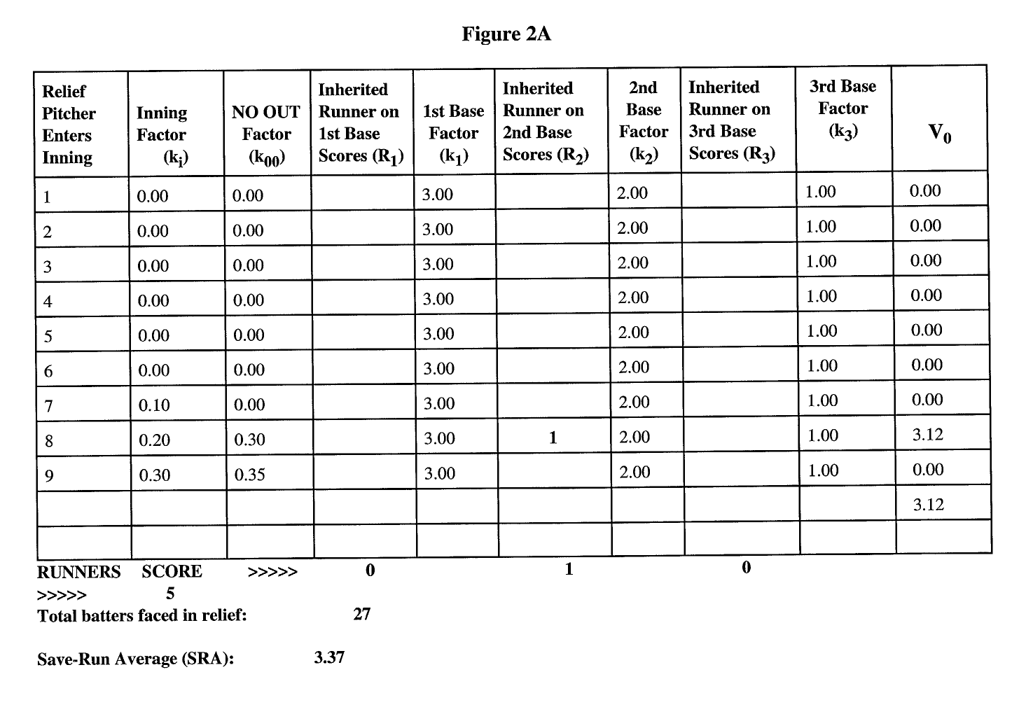

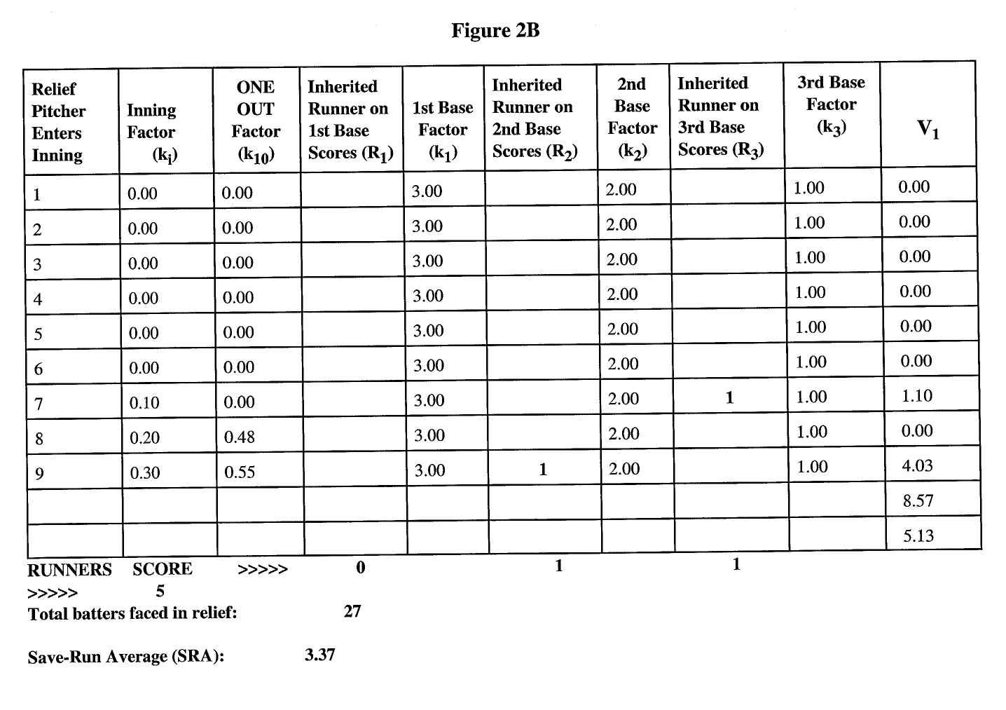

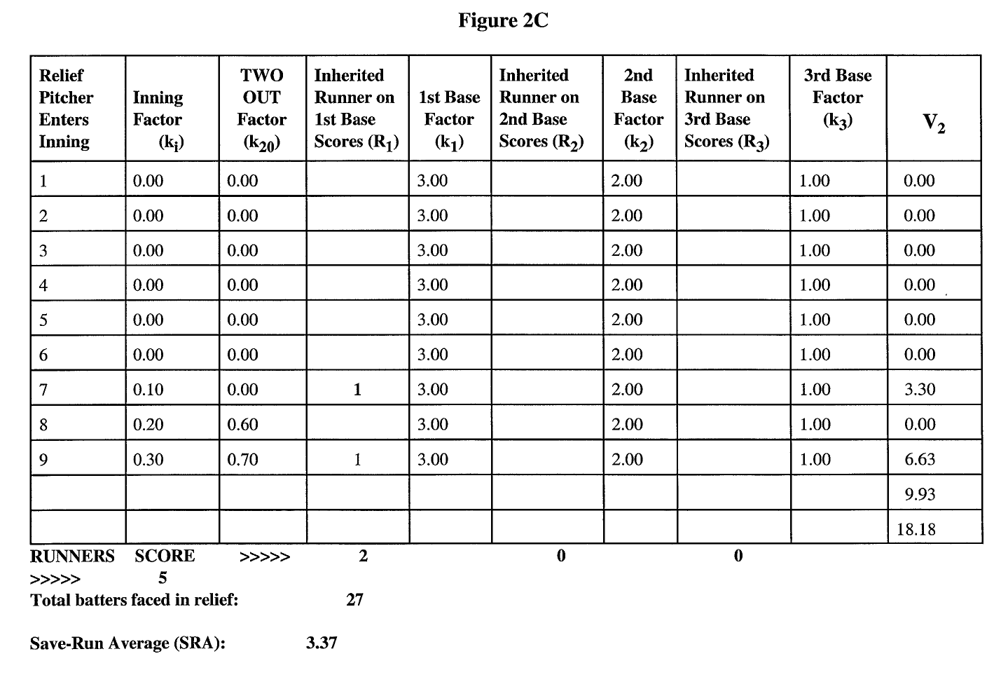

The attached FIGS. 1A, 1B and 1C and 2A, 2B and 2C are two spreadsheets illustrating examples of computations of Save-Run Averages (SRAs) in accordance with the present invention for two different game conditions. This SRA functions to more clearly define the value and performance of a relief pitcher. As things are now, a relief pitcher who comes into a game with his team ahead will, in circumstances previously described, receive a “save” (provided, of course, that the team stays ahead). But if several relief pitchers each have achieved the same number of saves, will each have the same value as a relief pitcher?

The current use of baseball statistics does not provide an accurate tool by which to measure the value of a relief pitcher. Fortunately, using the SRA statistic we can now more clearly define relief pitcher superiority.

For purposes of this invention, the SRA is an average that is directly proportional to the number of runs scored by players on base inherited by a relief pitcher, and inversely proportional to the number of batters faced in the final innings of the game. Therefore, in its most fundamental or basic aspect, the SRA can be represented as follows:

$$SRA = k ( \frac{R}{B} )$$

where k is a predetermined constant selected to scale the SRA to a selected range of magnitudes, and may be equal to “1”. However, as suggested, the SRA can be significantly refined to more fully reflect the value or performance of a relief pitcher in the final innings of the game. For purposes of discussing such refinements, the following definitions will be used:

(1) The Inning Factors—Preferably, these factors exist for the seventh, eighth, and ninth innings only. Through the sixth inning there is little pressure for a relief pitcher, as the game has a substantial amount of time left. As the game enters the seventh inning, the pressure mounts for the relief pitcher to hold the opposite team back. The “Inning Factor” variable “kᵢ” is increased as the game progresses through the seventh, eighth, and ninth innings, as the pressure increases and as the amount of time to correct a miscue decreases for a team. In short, the SRA reflects a greater penalty for failure as the game progresses.

(2) The Out Factor—the more outs there are when a relief pitcher enters the game, the more the reliever is penalized for a miscue. For example, if in the eighth inning with a player on first base the pitcher allows a runner to score with one out he is penalized by a factor of 0.48; if he allows the runner to score with two outs the penalty “out factor” 0.6. These factors are used because there is more pressure on the relief pitcher when he is pitching to a batter with, for example, two outs in the ninth inning than to a batter with no outs, so he is penalized more in these circumstances.

(3) The Base Factor—It takes a greater miscue to allow a runner to score from first base than it does to allow one to score from third base. Thus, the pitcher is penalized to a greater extent if the player on first scores under the same conditions as in a situation in which the player on third scores.

Turning now to specific examples of computations of SRAs in accordance with the more refined formula in accordance with the invention, and first referring to FIGS. 1A, 1B and 1C, it should be noted that the tables or spreadsheets show cumulative data for a pitcher over a number of games and not just one game. The data may be calculated over a season or over a lifetime of games for a pitcher.

In the initial column, the inning is indicated in which the relief pitcher enters. This can, of course, be in any inning, but, as noted above, the SRA only takes into account the seventh, eighth and ninth-plus innings. Because a game can include extra innings, and should the game go into such extra innings, the same variables, factors and constants as used for the ninth inning are preferably also used for any succeeding inning(s).

The second column provides an “Inning Factor.” It will be noted that the Inning Factor increases from Inning 7 to Inning 8 to Inning 9. The Inning Factor is designated as “kᵢ”.

The third column in FIG. 1A lists a factor reflecting “0” or “no outs” during Innings 7, 8 and 9, when a pitcher might be called in. The “Zero Out Factor” is represented by “k₀₀”, this factor increasing throughout the three final innings of the game. Thus, if a pitcher enters the seventh inning with no outs, he is penalized less than if he enters the eighth inning with no outs. He is penalized even more, then, if he enters the ninth inning with no outs, and allows inherited runners to score.

The fifth, seventh and ninth columns list factors k₁, k₂ and k₃. These factors represent parameters that are associated with inherited runners on first base, second base and third base, respectively. It will be noted that the factors k₁, k₂ and k₃ decrease as the position of the inherited runner moves up from first to second to third base. Therefore, if an inherited runner on first base scores, the pitcher will be penalized more severely than if he enters the game with an inherited runner on third base, and that runner scores.

The fourth, sixth and eighth columns set forth the inherited runners on respective bases that may be found when the relief pitcher enters the game. With the aforementioned data entered into the respective columns, a first component, “V₀,” is computed as follows:

$${V}_{0} = ( {R}_{1} {k}_{1} + {R}_{1} {k}_{1} {k}_{i} ) ( 1 + {k}_{00} ) + ( {R}_{2} {k}_{2} + {R}_{2} {k}_{2} {k}_{i} ) ( 1 + {k}_{00} ) + ( {R}_{3} {k}_{3} + {R}_{3} {k}_{3} {k}_{i} ) ( 1 + {k}_{00} ) .$$

The value V₀ is computed for each inning during which inherited runners are on base when a relief pitcher enters the game. In the example given, V₀=3.12, on the basis of an inherited runner on second base in the eighth inning, and V₀=5.27, in connection with the inherited runner on first base during the ninth inning. In both case, the V₀ values are added for a total value of V₀=8.39.

Similar computations are performed using the next seven columns, in which the factors k₁, k₂ and k₃ are the same. The only difference from the first set of columns is that in the first column in this set (FIG. 1B), there is “one out” when the pitcher enters the game. For this reason, the first factor k₁₀ differs from the values of column 3 in FIG. 1A. Thus, it will be noted that k₁₀, for the same inning, will increase when there is one out, as opposed to no outs. Therefore, the pitcher is being more severely penalized if he enters the game with one out and an inherited runner scores than he would be if he had entered the game with no outs and that same runner scored. Again, using the same expression (2) above, values of V₁ are computed for each inning as follows:

$${V}_{1} = ( {R}_{1} {k}_{1} + {R}_{1} {k}_{1} {k}_{i} ) ( 1 + {k}_{10} ) + ( {R}_{2} {k}_{2} + {R}_{2} {k}_{2} {k}_{i} ) ( 1 + {k}_{10} ) + ( {R}_{3} {k}_{3} + {R}_{3} {k}_{3} {k}_{i} ) ( 1 + {k}_{10} ) .$$

In this case, the total of the V₁ values is zero since no runs have been scored from any base with only one out.

Finally, referring to FIG. 1C, similar computations are performed for the last seven columns in which the constants are the same with the exception that the first column for k₂₀ is increased even further than the corresponding factors or values k₀₀ and k₁₀. For the same reasons mentioned previously, this is to penalize the pitcher more severely in the event that an inherited runner scores when there are two outs when the relief pitcher comes into the game. Again, using the same expression (2), the values V₂ are computed for each inning as follows:

$${V}_{2} = ( {R}_{1} {k}_{1} + {R}_{1} {k}_{1} {k}_{i} ) ( 1 + {k}_{20} ) + ( {R}_{2} {k}_{2} + {R}_{2} {k}_{2} {k}_{i} ) ( 1 + {k}_{20} ) + ( {R}_{3} {k}_{3} + {R}_{3} {k}_{3} {k}_{i} ) ( 1 + {k}_{20} ) .$$

In the example shown in FIG. 1C, the total of V₂ is equal to 9.93 on the basis of two runs in the seventh and ninth innings with players on first base.

It will be noted that each of the quantities V₀, V₁ and V₂ (equations 2, 3 and 4) reflects the number of runs scored, with each run R modified or weighted by the factor multipliers.

The SRA can now been computed as follows, using formula (1) and using k=5 and B=27:

$$SRA = \frac{5 ( {V}_{0} + {V}_{1} + {V}_{2} )}{B}$$

In the example illustrated, where the pitcher faced 27 batters,

SRA=5(8.39+0+9.93)÷27

SRA=3.39.

The constant “5” is not critical for purposes of the present invention and is merely a scaling factor that can be selected to scale the general resulting computation to a number that is manageable, easy to remember or otherwise convenient. The SRA may also be scaled to a number that is generally consistent with other baseball averages, as both fans and clubs may be most more familiar and more comfortable with them.

Referring to FIGS. 2A, 2B and 2C, the same factors are utilized. However, here there is one inherited runner on second base in the eighth inning with no outs, two inherited runners with one out on second and third bases in the seventh and ninth innings and two inherited runners on first base in the seventh and ninth inning, with two outs. Here, with the total number of batters faced in relief also being equal to 27, the SRA is computed as 3.03, using the identical formula or computation.

The distinctions between the SRA and ERA become immediately evident. Thus, for example, in a nine-inning game, with three outs per inning, there are a total of 27 outs. In the ideal game, therefore, there are 27 batters out in one game. The ERA, as noted above, is equal to the number of runs divided by the number of batters, itself divided by 27 (the number of outs). Therefore, in the ideal game, the number of runs is equal to zero, and the ERA is equal to zero. However, if the number of runs is equal to 1, the ERA is equal to 1. If the pitcher faces 54 batters, the ERA is equal to 0.5. Stated otherwise, the ERA is a reflection of the number of runners who have scored for every 27 outs. However, this is without regard to the number of inherited runners, the number of innings in which the runs were scored, the bases on which the inherited runners were on, etc. However, the SRA provides more information about the real performance of the relief pitcher. Thus, the greater the number of inherited runners that score, the higher the SRA. The SRA also increases if such runs are scored in later innings, or from lower bases.

It will be evident, therefore, that the SRA provides a more accurate and more complete picture of the capabilities or performance of a relief pitcher in the circumstances described. By using the formula for the SRA, in its broader or more refined form, a numerical value can be placed on what the relief pitcher has saved. In other words, “a save is not a save is not a save.” All saves are not equal. The SRA in accordance with the present invention makes the necessary adjustment to reflect this and serves as a valuable tool and criterion for analysis when comparing relief pitchers in the final innings of a baseball game.

While this invention has been described in detail with particular reference to preferred embodiments thereof, it will be understood that variations and modifications will be effected within the spirit and scope of the invention as described herein and as defined in the appended claims. Thus, for example, formulas (2)-(4) can be modified to add, delete or give different weights to any of the factors that serve as multipliers for the runs R₁, R₂ and/or R₃. The “out” factors k₀₀, k₁₀ and k₂₀ may be discounted or made equal to zero. While this simplifies the computation, it eliminates the statistic's ability to vary the weight to runs scored when there are different numbers of outs at the time that the relief pitcher is called in. It should also be clear that each of the factors (e.g., kᵢ) can be adjusted to penalize a pitcher more or less as conditions vary. The factors can be incrementally increased or decreased, or can be inverted and adjusted as a divisor instead of a multiplier in the equations (e.g., (R₁ k₁÷kᵢ) instead of (R₁ k₁ X kᵢ) as in equation (2)). Additional factors not currently reflected in the equations for the SRA might also be added —such as, for example, whether the game is a night game, poor weather conditions (e.g., rain)—all of which may make it easier or more difficult for a pitcher to perform well.

What I claim:

1. A method of evaluating the performance of a relief pitcher in the late innings of a baseball game in which the pitcher inherits at least one player on base, the method comprising the steps of establishing the number of runs R scored by such inherited players; establishing the number of batters B faced in such innings; and evaluating the save-run average “SRA”, where:
$$SRA = k ( \frac{R}{B} )$$
where k is a predetermined constant selected to scale the SRA to a desired range of magnitudes.

2. A method as defined in claim 1, wherein the runs R are modified or weighed by at least one factor reflecting a condition in the baseball game at the time that the relief pitcher is brought into the game.

3. A method as defined in claim 2, wherein the runs R are modified by a plurality of weighing factors.

4. A method as defined in claim 2, wherein said factor is a function of the number of the inning.

5. A method as defined in claim 4, wherein said factor increases for each subsequent inning.

6. A method as defined in claim 2, wherein said factor is a function of the number of outs.

7. A method as defined in claim 6, wherein said factor increases as the game moves through the innings.

8. A method as defined in claim 6, wherein said factor increases with the number of outs.

9. A method as defined in claim 2, wherein said factor is a function of the base on which the inherited player is on.

10. A method as defined in claim 9, wherein said factor decreases as the base number increases.

11. A method as defined in claim 1, wherein a constant “k” is selected to provide an SRA in the range of 1-10.

12. A method as defined in claim 1, wherein said SRA is computed on the basis of a pitcher's performance within at least a part of one season.

13. A method as defined in claim 1, wherein said SRA is compiled on a pitcher's performance over a lifetime of pitching.

14. A method as defined in claim 1, wherein the SRA is compiled as follows:
$$\begin{matrix}SRA = k [ ( {R}_{1} {k}_{1} ) ( 1 + {k}_{i} ) ( 1 + {k}_{00} ) + \\ ( {R}_{2} {k}_{2} ) ( 1 + {k}_{i} ) ( 1 + {k}_{00} ) + \\ ( {R}_{3} {k}_{3} ) ( 1 + {k}_{i} ) ( 1 + {k}_{00} ) + \\ ( {R}_{1} {k}_{1} ) ( 1 + {k}_{i} ) ( 1 + {k}_{10} ) + \\ ( {R}_{2} {k}_{2} ) ( 1 + {k}_{i} ) ( 1 + {k}_{10} ) + \\ ( {R}_{3} {k}_{3} ) ( 1 + {k}_{i} ) ( 1 + {k}_{10} ) + \\ ( {R}_{1} {k}_{1} ) ( 1 + {k}_{i} ) ( 1 + {k}_{20} ) + \\ ( {R}_{2} {k}_{2} ) ( 1 + {k}_{i} ) ( 1 + {k}_{20} ) + \\ ( {R}_{3} {k}_{3} ) ( 1 + {k}_{i} ) ( 1 + {k}_{20} ) \div B ,\end{matrix}$$
where kᵢ is an inning factor;
k₀₀, k₁₀ and k₂₀ are “number out” factors;
k is an SRA scaling factor;
k₁, k₂ and k₃ are “base” factors; and
R₁, R₂ and R₃ are the number of runs scored by players on first, second and third bases.

15. An apparatus for evaluating the performance of a relief pitcher in the final innings of a baseball game in which the pitcher inherits at least one player on base, comprising:
means for establishing the number of runs R scored by such inherited player;
means for establishing the number of batters B faced in such innings; and
means for evaluating the save-run average “SRA”, where:
$$SRA = k ( \frac{R}{B} ) ,$$
and k is a predetermined constant selected to scale the SRA to a desired range of magnitudes.

16. An apparatus as defined in claim 15, wherein said evaluation means comprises a computer programmed to perform the required computations when the number of runs (R) and number of batters faced (B) are entered.

17. An evaluation parameter for evaluating or comparing the performance or efficiency of a relief pitcher in the final innings of a baseball game in which the pitcher inherits at least one player on base, the parameter being defined as follows:
$$SRA = k ( \frac{R}{B} ) ,$$
where R is equal to the number of runs scored by the inherited players, B is the number of batters faced by the pitcher and k is a predetermined constant selected to scale the SRA to a desired range of magnitudes.

18. An evaluation parameter as defined in claim 17, wherein the SRA is compiled as follows:
$$\begin{matrix}SRA = k [ ( {R}_{1} {k}_{1} ) ( 1 + {k}_{i} ) ( 1 + {k}_{00} ) + \\ ( {R}_{2} {k}_{2} ) ( 1 + {k}_{i} ) ( 1 + {k}_{00} ) + \\ ( {R}_{3} {k}_{3} ) ( 1 + {k}_{i} ) ( 1 + {k}_{00} ) + \\ ( {R}_{1} {k}_{1} ) ( 1 + {k}_{i} ) ( 1 + {k}_{10} ) + \\ ( {R}_{2} {k}_{2} ) ( 1 + {k}_{i} ) ( 1 + {k}_{10} ) + \\ ( {R}_{3} {k}_{3} ) ( 1 + {k}_{i} ) ( 1 + {k}_{10} ) + \\ ( {R}_{1} {k}_{1} ) ( 1 + {k}_{i} ) ( 1 + {k}_{20} ) + \\ ( {R}_{2} {k}_{2} ) ( 1 + {k}_{i} ) ( 1 + {k}_{20} ) + \\ ( {R}_{3} {k}_{3} ) ( 1 + {k}_{i} ) ( 1 + {k}_{20} ) \div B ,\end{matrix}$$
where kᵢ is an inning factor;
k₀₀, k₁₀ and k₂₀ are “number of out” factors;
k is an SRA scaling factor;
k₁, k₂ and k₃ are “base” factors; and
R₁, R₂ and R₃ are the number of runs scored by players on first, second and third bases.

19. An evaluation parameter as defined in claim 17, wherein k is selected to provide an SRA in the range of 1-10.

20. An evaluation parameter as defined in claim 17, wherein said SRA is computed on the basis of a pitcher's performance within at least a part of one season.

21. An evaluation parameter as defined in claim 17, wherein said SRA is compiled on a pitcher's performance over a lifetime of pitching.
